(19) United States
(12) Patent Application Publication
(10) Pub. No.: US 2022/0315200 A1
(43) Pub. Date: Oct. 6, 2022

(54) LANDING GEAR BAY COMPRISING A BOTTOM WALL HAVING A VAULTED FORM, AND AIRCRAFT COMPRISING SAID LANDING GEAR BAY

(71) Applicant: Airbus Operations SAS, TOULOUSE (FR)

(72) Inventors: Benoit ORTEU, TOULOUSE (FR); Damien SIRE, TOULOUSE (FR)

(21) Appl. No.: 17/712,413

(22) Filed: Apr. 4, 2022

(30) Foreign Application Priority Data
Apr. 6, 2021 (FR) 2103476

(51) Int. Cl. B64C 1/18; B64C 1/10; B64C 25/00; B64C 25/04; B64C 25/10

(52) U.S. Cl. CPC B64C 1/18; B64C 1/10; B64C 25/001; B64C 25/04; B64C 25/10; B64C 2025/125

(57) ABSTRACT

A landing gear bay including a bottom wall which includes longitudinal beams and at least one panel forming an airtight barrier between first and second zones disposed on either side of the panel. The panel has first and second longitudinal edges each linked to one of the longitudinal beams. The second zone is configured to sustain a pressure greater than that of the first zone. The panel has a profile that is substantially constant in the longitudinal direction and includes at least one central part offset toward the second zone with respect to its first and second longitudinal edges. This solution makes it possible to limit the vertical stresses applied to the longitudinal beams by virtue of the pressure difference between the first and second zones.

### CROSS-REFERENCES TO RELATED APPLICATIONS

This application claims the benefit of the French patent application No. 2103476 filed on Apr. 6, 2021, the entire disclosures of which are incorporated herein by way of reference.

### FIELD OF THE INVENTION

The present invention relates to a landing gear bay comprising a bottom wall having a vaulted form and to an aircraft comprising said landing gear bay.

### BACKGROUND OF THE INVENTION

As illustrated in FIGS. 1 and 2, an aircraft 10 comprises a fuselage 12 which extends between a nose cone 14 and a tail cone 16, and wings 18 disposed on either side of the fuselage 12 and linked thereto by a central wing box 20.

For the rest of the description, a longitudinal axis 22 of the aircraft 10 corresponds to the horizontal axis, when the aircraft 10 is on the ground, which extends from the nose cone 14 to the tail cone 16 of the aircraft 10. A longitudinal direction is a direction parallel to the longitudinal axis 22. A longitudinal plane is a plane which is parallel to the longitudinal axis 22. A vertical median plane is a vertical plane passing through the longitudinal axis 22. A transverse plane is a plane at right angles to the longitudinal axis 22.

The aircraft 10 comprises a front landing gear 24 positioned in proximity to the nose cone 14 and two main landing gears 26 positioned on either side of the fuselage 12, to the rear of the central wing box 20. Each front or main landing gear 24, 26 is configured to occupy a deployed position, as illustrated in FIG. 1, in which it is positioned outside of a gear bay, and a retracted position in which it is positioned in the gear bay, as illustrated in FIG. 4.

As illustrated in FIGS. 2 to 4, the fuselage 12 comprises a main landing gear bay 28 positioned to the rear of the central wing box 20 and configured to receive the two main landing gears 26 in the retracted position. This main landing gear bay 28 comprises a rear transverse wall 30.1, a front transverse wall 30.2 and a bottom wall 30.3. Some of these walls, notably the rear transverse wall 30.1 and the bottom wall 30.3, form an airtight barrier between a pressurized first zone, inside the fuselage 12 and outside the main landing gear bay 28, and an unpressurized second zone inside the main landing gear bay 28. Because of this pressure difference, the bottom wall 30.3 bends inward toward the interior of the main landing gear bay 28, as illustrated in FIG. 4. To limit this deformation, the bottom wall 30.3 is reinforced and comprises several longitudinal beams 32 parallel to one another, oriented parallel to the longitudinal direction and which extend from the rear transverse wall 30.1 to the front transverse wall 30.2.

According to an embodiment that can be seen in FIGS. 5 and 6, the bottom wall 30.3 also comprises several approximately rectangular membranes 34 linking the longitudinal beams 32. Each membrane 34 curves inward toward the interior of the main landing gear bay 28 and comprises a first longitudinal edge 34.1 linked to a first longitudinal beam 32.1 and a second longitudinal edge 34.2 linked to a second longitudinal beam 32.2. In addition, each longitudinal beam 32, 32.1, 32.2 comprises a flange 36 against which the first longitudinal edge 34.1 of a first membrane 34 and the second longitudinal edge 34.2 of a second membrane 34 are pressed. According to this embodiment, the flanges 36 are coplanar.

According to this embodiment, the pressure exerted on the bottom wall 30.3 because of the pressure difference between the first and second zones is supported by longitudinal beams 32 which take up all of the load. Because of this, the longitudinal beams 32 bend vertically. To limit this bending, it is necessary to reinforce the longitudinal beams 32 or provide them in greater numbers which tends to increase the onboard weight.

The document EP2824031 describes, in FIG. 10, a landing gear bay. The latter comprises a bottom wall and a vertical wall comprising longitudinal or vertical beams and panels linked to the longitudinal beams. Each panel comprises discontinuous hollowed-out cavities (which do not extend from one edge to the other of the panel) to increase its stiffness. Given the stress differences from one zone to another of a panel, the arrangement of the hollowed-out cavities varies from one zone to the other.

As previously, the pressure exerted on the bottom wall because of the pressure difference on either side of the bottom wall is supported by longitudinal beams which take up all of the load. Because of this, the longitudinal beams bend vertically.

### SUMMARY OF THE INVENTION

The present invention aims to wholly or partly remedy the drawbacks of the prior art.

To this end, a subject of the invention is a landing gear bay comprising a bottom wall having a rear edge, a front edge parallel to the rear edge and at right angles to a vertical median plane, and first and second lateral edges parallel to the vertical median plane, the bottom wall comprising longitudinal beams linking the rear and front edges, parallel to the vertical median plane, and at least one panel forming an airtight barrier between first and second zones disposed on either side of the panel, said panel having first and second longitudinal edges each linked to one of the longitudinal beams, the second zone having a pressure greater than that of the first zone in flight.

According to the invention, the panel has a profile that is substantially constant in the longitudinal direction and comprises at least one central part offset toward the second zone with respect to its first and second longitudinal edges.

Thus, the loads applied to the panel, because of the pressure difference between the first and second zones, induce stresses on the longitudinal beams comprising a horizontal component and not only a vertical component as in the prior art, which contributes to reducing the vertical stresses applied to the longitudinal beams.

According to another feature, the first and second longitudinal edges are positioned in a same horizontal plane.

According to a first variant, the panel has a curved profile in a transverse plane.

According to a second variant, the panel comprises a substantially horizontal flat central part and first and second flat and inclined lateral parts such that the central part is offset toward the second zone with respect to the first and second longitudinal edges.

According to another feature, at least one longitudinal beam comprises a web, first and second flange portions, disposed on either side of the web, each supporting a panel, the first and second flange portions converging at the web.

According to one arrangement, the bottom wall comprises a first end longitudinal beam positioned in proximity to or at the first lateral edge, a second end longitudinal beam positioned in proximity to or at the second lateral edge, first and second central longitudinal beams disposed on either side of the vertical median plane, a first pair of first and second intermediate longitudinal beams inserted between the first end and central longitudinal beams and a second pair of first and second intermediate longitudinal beams inserted between the second end and central longitudinal beams.

In addition, the bottom wall comprises a central panel linking the first and second central longitudinal beams, a first lateral panel linking the first end longitudinal beam and the first central longitudinal beam, and a second lateral panel linking the second central longitudinal beam and the second end longitudinal beam, each of the first and second lateral panels having a central part offset toward the second zone with respect to its first and second longitudinal edges, positioned in a same horizontal plane.

According to another feature, one of the first and second flange portions of the first or second end longitudinal beam is inclined and has a free end offset toward the second zone and a face oriented toward the second zone against which the first or second longitudinal edge of the first or second lateral panel is pressed and fixed.

According to another feature, the first flange portion of the first or second central longitudinal beam is inclined and has a free end offset toward the second zone and a face oriented toward the first zone against which the first or second longitudinal edge of the first or second lateral panel is pressed and fixed. In addition, the second flange portion of the first or second central longitudinal beam is substantially horizontal and has a face oriented toward the first zone against which the first or second longitudinal edge of the central panel is pressed and fixed.

According to another feature, the first and second flange portions of each of the first and second intermediate longitudinal beams are inclined, the first or second lateral panel being pressed and fixed against the first and second flange portions.

According to another feature, at least one panel comprises transverse ribs added onto a face of the panel oriented toward the first zone.

Also, a subject of the invention is an aircraft comprising a landing gear bay according to one of the preceding features.

### BRIEF DESCRIPTION OF THE DRAWINGS

Other features and advantages will emerge from the following description of the invention, a description given purely by way of example, in light of the attached drawings in which:

FIG. 1 is a side view of an aircraft,

FIG. 2 is a longitudinal cross-section of a part of the fuselage of the aircraft visible in FIG. 1,

FIG. 3 is a perspective view of an empty main landing gear bay illustrating an embodiment of the prior art,

FIG. 4 is a longitudinal cross-section of the main landing gear bay, visible in FIG. 3, showing a deformation of a bottom wall,

FIG. 5 is a transverse cross-section of the main landing gear bay visible in FIG. 3,

FIG. 6 is a schematic transverse cross-section of the bottom wall of a main landing gear bay illustrating an embodiment of the prior art,

FIG. 7 is a perspective view of a main landing gear bay illustrating an embodiment of the invention,

FIG. 8 is a perspective view of a bottom wall of the main landing gear bay visible in FIG. 7,

FIG. 9 is a longitudinal cross-section of the main landing gear bay visible in FIG. 7,

FIG. 10 is a transverse cross-section of the main landing gear bay visible in FIG. 7,

FIG. 11 is an overlay of a transverse cross-section of a bottom wall of a main landing gear bay illustrating the embodiment of the invention visible in FIG. 7 and of a transverse cross-section of a bottom wall of a main landing gear bay illustrating an embodiment of the prior art,

FIG. 12 is a transverse cross-section of a bottom wall of a main landing gear bay illustrating another embodiment of the invention,

FIG. 13 is a cross-section of a first part of a bottom wall of a main landing gear bay illustrating an embodiment of the invention,

FIG. 14 is a cross-section of a second part of a bottom wall of a main landing gear bay illustrating an embodiment of the invention, and

FIG. 15 is a cross-section of a third part of a bottom wall of a main landing gear bay illustrating an embodiment of the invention.

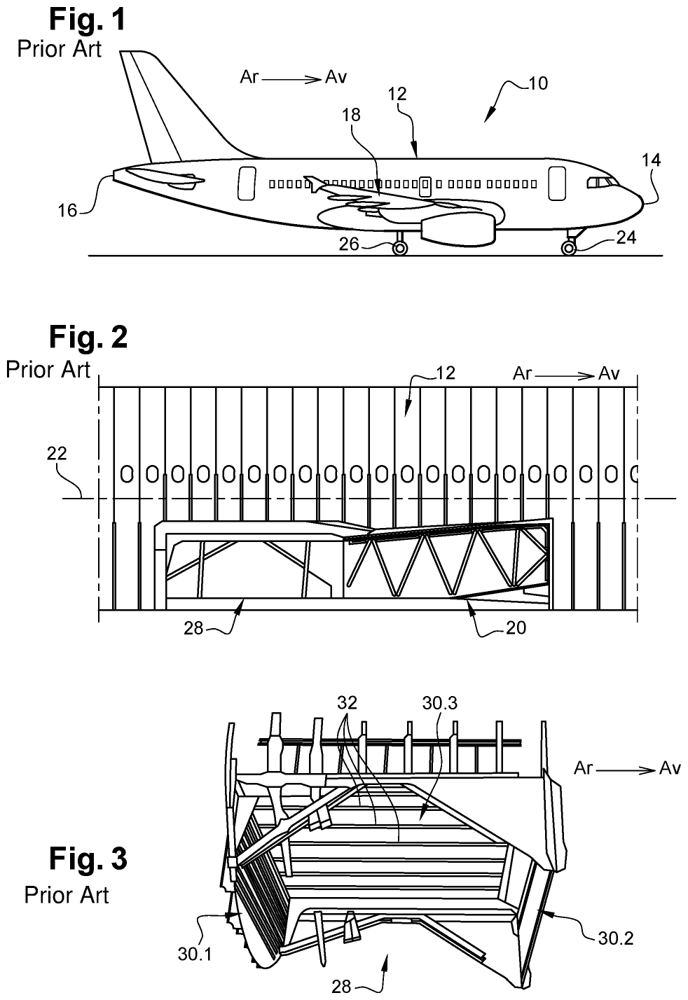

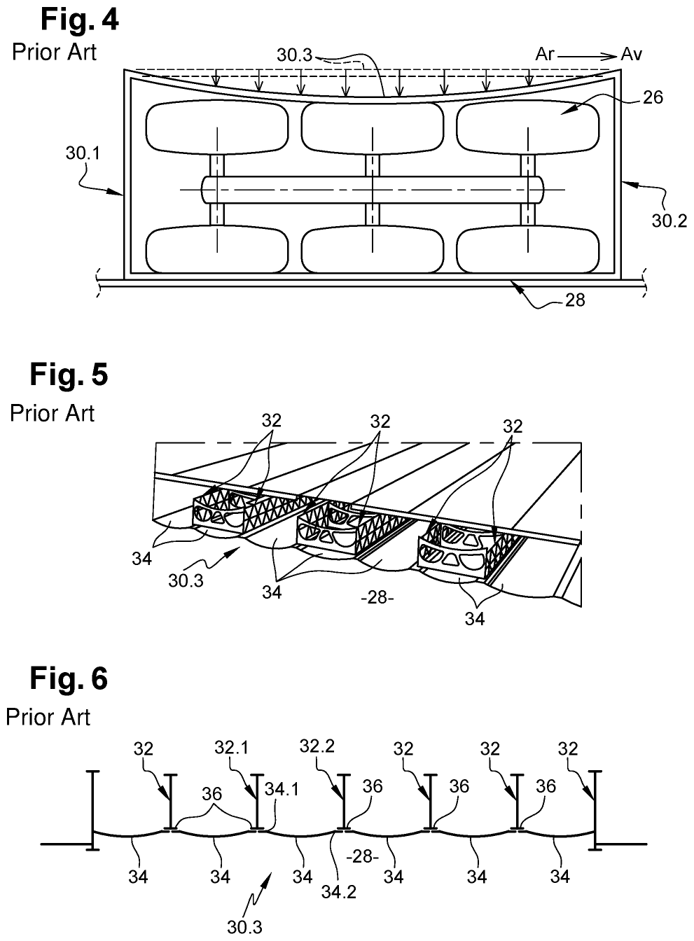

### DETAILED DESCRIPTION OF THE PREFERRED EMBODIMENTS

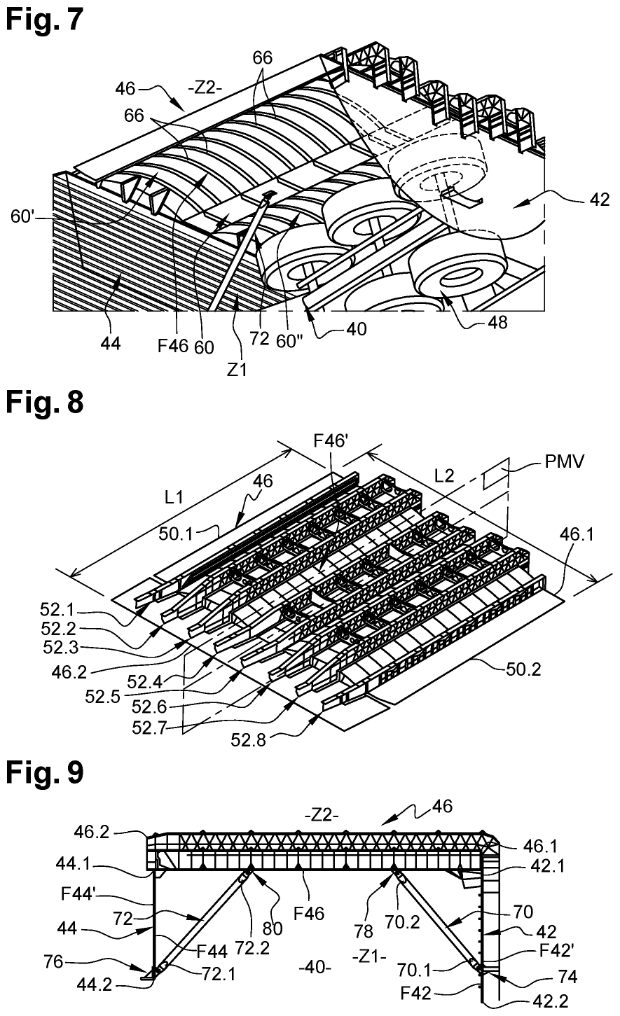

According to an embodiment visible in FIGS. 7 to 9, a main landing gear bay 40 comprises a rear transverse wall 42 at right angles to a vertical median plane PMV, a front transverse wall 44 approximately parallel to the rear transverse wall 42, and a bottom wall 46 approximately at right angles to the rear and front transverse walls 42, 44 and to the vertical median plane PMV. The bottom wall 46 is positioned symmetrically with respect to the vertical median plane PMV. The front transverse wall 44 can form part of a central wing box.

The main landing gear bay 40 delimits a first zone Z1 configured to house two main landing gears 48 (just one visible in FIG. 7) when they are in retracted position, positioned on either side of the vertical median plane PMV, as illustrated in FIG. 7. The bottom wall 46, and possibly at least one of the rear and front transverse walls 42, 44, separates/separate the first zone Z1, unpressurized, from a second zone Z2, pressurized, situated inside the fuselage and outside of the main landing gear bay 40. Thus, in flight, the second zone Z2 has a pressure greater than that of the first zone Z1. According to one configuration, the bottom wall 46 and the rear transverse wall 42 separate the unpressurized first zone Z1 from the pressurized second zone Z2 and form an airtight barrier.

The rear transverse wall 42 comprises a top side 42.1 linked to the bottom wall 46 and a bottom side 42.2 away from the bottom wall 46. The front transverse wall 44 comprises a top side 44.1 linked to the bottom wall 46 and a bottom side 44.2 away from the bottom wall 46. The bottom wall 46 comprises a rear edge 46.1 linked to the top side 42.1 of the rear transverse wall 42 and a front edge 46.2 linked to the top side 44.1 of the front transverse wall 44. The bottom wall 46 also comprises first and second lateral edges 50.1, 50.2 parallel to the vertical median plane PMV. The bottom wall 46 has a length L1 separating the rear and front edges 46.1, 46.2, a dimension taken in a direction parallel to the longitudinal direction, and a width L2 separating the first and second lateral edges 50.1, 50.2, a dimension taken in a direction at right angles to the longitudinal direction.

The rear transverse wall 42 comprises an inner face F42 oriented toward the first zone Z1 of the main landing gear bay 40 and an outer face F42′ opposite the inner face F42. The front transverse wall 44 comprises an inner face F44 oriented toward the first zone Z1 of the main landing gear bay 40 and an outer face F44′ opposite the inner face F44. The bottom wall 46 comprises an inner face F46 oriented toward the first zone Z1 of the main landing gear bay 40.

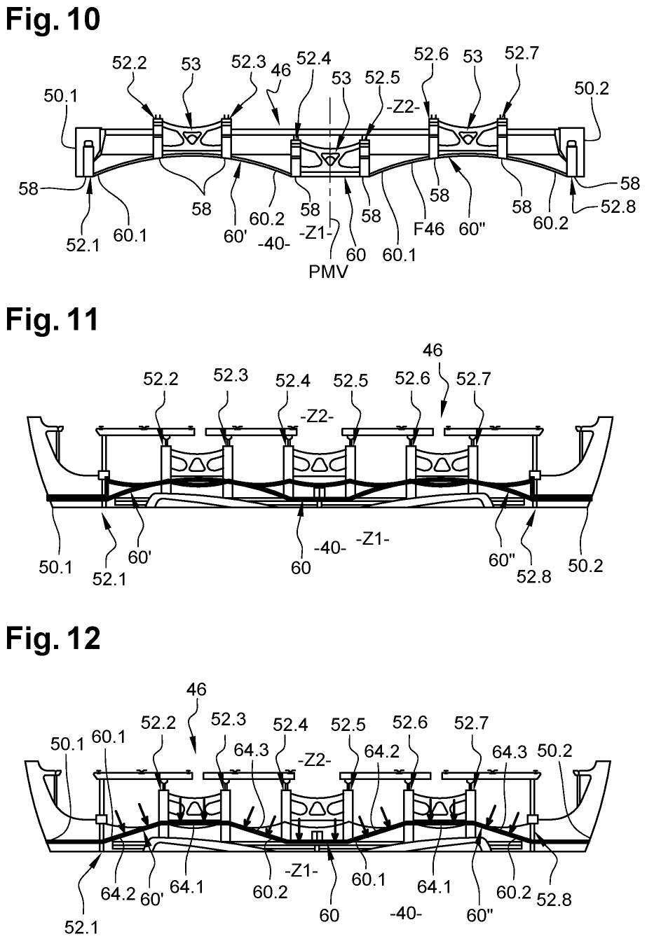

According to a configuration visible in FIGS. 8 to 10, the bottom wall 46 is reinforced and comprises longitudinal beams 52.1 to 52.8 linking the rear and front edges 46.1, 46.2, parallel to the vertical median plane PMV, positioned symmetrically with respect to the vertical median plane PMV. These longitudinal beams 52.1, 52.8 are distributed over the width of the bottom wall 46 (dimension taken in the transverse direction). According to one configuration, the bottom wall 46 comprises eight longitudinal beams 52.1 to 52.8. According to an arrangement visible in FIGS. 8 and 10, the bottom wall 46 comprises a first end longitudinal beam 52.1 positioned in proximity to or at the first lateral edge 50.1, a second end longitudinal beam 52.8 positioned in proximity to or at the second lateral edge 50.2, first and second central longitudinal beams 52.4, 52.5 disposed on either side of the vertical median plane PMV, a first pair of first and second intermediate longitudinal beams 52.2, 52.3 inserted between the first end and central longitudinal beams 52.1, 52.4 and a second pair of first and second intermediate longitudinal beams 52.6, 52.7 inserted between the second end and central longitudinal beams 52.5, 52.8.

According to one embodiment, the central longitudinal beams 52.4, 52.5 are linked by transverse reinforcements 53. Likewise, the first and second intermediate beams 52.2, 52.3, 52.6, 52.7 of each of the first and second pairs are linked pairwise by transverse reinforcements 53.

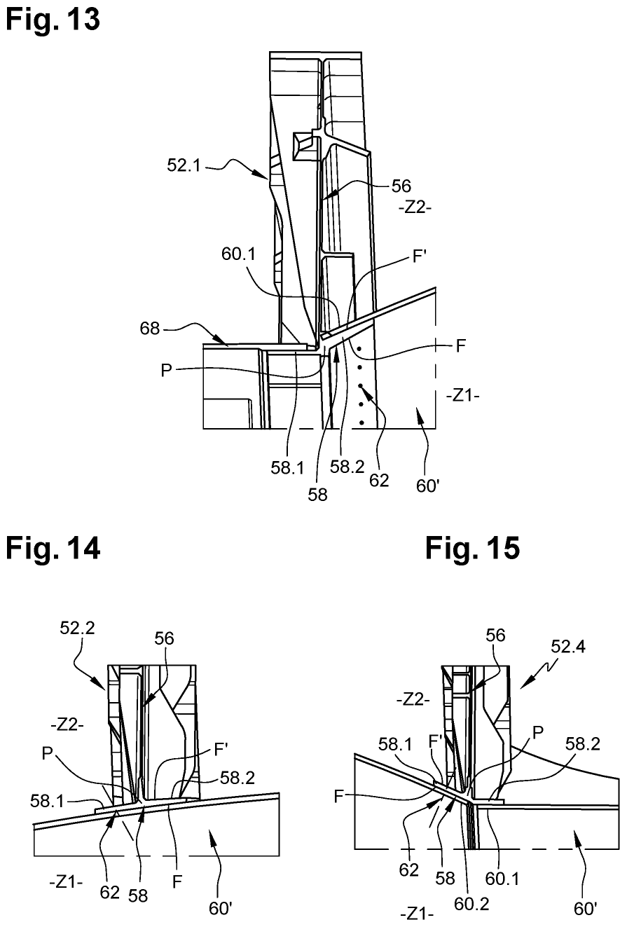

As illustrated in FIGS. 13 to 15, each longitudinal beam 52.1 to 52.8 comprises a web 56 positioned in a plane parallel to the vertical median plane PMV and at least one flange 58 positioned at one of the ends of the web 56 oriented toward the first zone Z1 of the main landing gear bay 40.

Each flange 58 has a first flange portion 58.1 disposed on a first side of the web 56 and a second flange portion 58.2 disposed on a second side of the web 56. Each of the first and second flange portions 58.1, 58.2 comprises a bottom face F oriented toward the first zone Z1 and a top face F′ oriented toward the second zone Z2.

The bottom wall 46 comprises at least one panel 60 which extends from the rear edge 46.1 to the front edge 46.2. A panel 60 forms an airtight barrier between the first and second zones Z1, Z2, made of metal or of a composite material, which has a small thickness. Each panel 60 is linked to at least two of the longitudinal beams 52.1 to 52.8.

Each panel 60 comprises first and second longitudinal edges 60.1, 60.2 parallel to the longitudinal direction.

According to a first configuration visible in FIGS. 7, 10 and 11, the bottom wall 46 comprises a central panel 60 linking the first and second central longitudinal beams 52.4, 52.5, a first lateral panel 60′ linking the first end longitudinal beam 52.1 and the first central longitudinal beam 52.4 and a second panel 60″ linking the second central longitudinal beam 52.5 and the second end longitudinal beam 52.8. Each of the central and lateral panels 60, 60′, 60″ extends from the rear edge 46.1 to the front edge 46.2.

According to another configuration, the bottom wall 46 comprises several panels 60, one between each pair of longitudinal beams 52.1 to 52.8.

According to another configuration, the bottom wall 46 comprises a single panel which extends from the first lateral edge 50.1 to the second lateral edge 50.2.

Obviously, the invention is not limited to these configurations for the panels.

According to a configuration visible in FIGS. 7, 10 and 11, in the state of rest and in the absence of a pressure difference between the first and second zones Z1 and Z2, at least one of the panels 60, 60′, 60″ has a radius of curvature in a transverse plane, substantially constant in the longitudinal direction. The fact that the panel is curved in a transverse plane makes it possible to increase its moment of inertia with respect to a flat panel, which contributes to increasing its resistance of bending in a vertical longitudinal plane. Thus, bending stresses applied to the longitudinal beams 52.1 to 52.8 are reduced.

According to another feature, the radius of curvature of the panel 60′, 60″ is oriented in such a way that the panel 60′, 60″ is curved toward the second zone Z2, in an opposite direction with respect to the loads exerted on the bottom wall 46 because of the pressure difference between the first and second zones Z1, Z2. According to one arrangement, the first and second longitudinal edges 60.1, 60.2 of the panel 60′, 60″ are positioned in a same horizontal plane and at least a part of the panel 60′, 60″ is offset toward the second zone Z2 with respect to the first and second longitudinal edges 60.1, 60.2 of the panel 60′, 60″. This arrangement makes it possible to obtain a uniform distribution of the loads toward the first and second longitudinal edges 60.1, 60.2. Because of the orientation of the curvature, the loads applied to the panel 60′, 60″, because of the pressure difference between the first and second zones Z1, Z2, induce stresses on the longitudinal beams 52.1 to 52.8 comprising a horizontal component (and not only a vertical component as in the prior art) at the first and second longitudinal edges 60.1, 60.2, which contributes to reducing the vertical stresses applied to the longitudinal beams 52.1 to 52.8.

The panels 60, 60′, 60″ are linked to the first and second flange portions 58.1, 58.2 of the longitudinal beams 52.1 to 52.8 by at least one link 62. As an example, this link 62 comprises a plurality of rivets, bolts or the like distributed in the longitudinal direction. As a variant, the link 62 is obtained by bonding, thermowelding or any other similar technique.

According to a configuration visible in FIG. 13, at least one edge out of the first and second longitudinal edges 60.1, 60.2 of the panel 60, 60′, 60″ is pressed against the top face F′ of the first or second flange portion 58.1, 58.2 of one of the longitudinal beams 52.1 to 52.8. This configuration contributes to reducing the stress on the link 62.

According to a configuration visible in FIGS. 7, 10 and 11, the first and second lateral panels 60, 60′ are curved and the central panel 60 is flat. As illustrated in FIG. 10, according to this configuration, the flanges 58 of the first and second end and central longitudinal beams 52.1, 52.4, 52.5, 52.8 are substantially coplanar and positioned in a first horizontal plane. The flanges 58 of the first and second intermediate longitudinal beams 52.2, 52.3, 52.6, 52.7 are substantially coplanar and positioned in a second plane, substantially parallel to the first plane and offset toward the second zone Z2 with respect to the first plane.

As illustrated in FIG. 15, the second flange portion 58.2 of the first end longitudinal beam 52.1 is inclined such that its free end is offset toward the second zone Z2. In addition, the first longitudinal edge 60.1 of the first lateral panel 60′ is pressed and fixed against the top face F′ of the second flange portion 58.2. Symmetrically, the first flange portion 58.1 of the second end longitudinal beam 52.8 is inclined such that its free end is offset toward the second zone Z2. In addition, the second longitudinal edge 60.2 of the second lateral panel 60″ is pressed and fixed against the top face F′ of the first flange portion 58.1.

As illustrated in FIG. 14, the first and second flange portions 58.1, 58.2 of the flange 58 of the first intermediate longitudinal beam 52.2 are inclined to follow the curved profile of the first lateral panel 60′ which is pressed and fixed against the bottom faces F of the first and second flange portions 58.1, 58.2. For this first intermediate longitudinal beam 52.2, the free end of the second flange portion 58.2 is offset toward the second zone Z2 with respect to the free end of the first flange portion 58.1.

The first and second flange portions 58.1, 58.2 of the second intermediate longitudinal beam 52.3 are also inclined, the free end of the second flange portion 58.2 being offset toward the first zone Z1 with respect to the free end of the first flange portion 58.1.

As illustrated in FIG. 15, the first flange portion 58.1 of the first central longitudinal beam 52.4 is inclined such that its free end is offset toward the second zone Z2. In addition, the second longitudinal edge 60.2 of the first lateral panel 60′ is pressed and fixed against the bottom face F of the first flange portion 58.1. The second flange portion 58.2 of the first central longitudinal beam 52.4 is substantially horizontal. In addition, the first longitudinal edge 60.1 of the central panel 60 is pressed and fixed against the bottom face F of the second flange portion 58.2.

The other joining zones between the panels 60, 60″ and the longitudinal beams 52.5 to 52.8 are not described because they are symmetrical to those previously described with respect to the vertical median plane PMV.

According to another configuration visible in FIG. 12, the lateral panels 60′, 60″ are not necessarily curved.

Thus, each of the first and second lateral panels 60′, 60″ comprises a substantially horizontal flat central part 64.1 and first and second flat and inclined lateral parts 64.2, 64.3 such that the central part 64.1 is offset toward the second zone Z2 with respect to the first and second longitudinal edges 60.1, 60.2.

Whatever the embodiment, the bottom wall 46 comprises at least one panel 60, 60′, 60″ which has a profile that is substantially constant in the longitudinal direction and which, at least in the absence of a pressure difference between the first and second zones Z1 and Z2, comprises at least one central part offset toward the second zone Z2 with respect to its first and second longitudinal edges 60.1, 60.2, each linked to a longitudinal beam 52.1 to 52.8. Thus, the loads applied to the panel 60, 60′, 60″, because of the pressure difference between the first and second zones Z1, Z2, will tend to move the longitudinal edges 60.1, 60.2 apart, which will induce stresses on the longitudinal beams 52.1 to 52.8 comprising a horizontal component (and not only a vertical component as in the prior art) at the first and second longitudinal edges 60.1, 60.2, and contribute to reducing the vertical stresses applied to the longitudinal beams 52.1 to 52.8.

For the symmetrical loads to be absorbed, the first and second longitudinal edges 60.1, 60.2 are substantially positioned in a same horizontal plane.

As illustrated in FIG. 7, at least one panel 60, 60′, 60″ comprises transverse ribs 66 added onto its face oriented toward the first zone Z1. These transverse ribs 66 are oriented at right angles to the longitudinal direction and evenly distributed over the length (direction parallel to the longitudinal direction) of the panel 60, 60′, 60″. According to one configuration, all the panels 60, 60′, 60″ are reinforced and comprise transverse ribs 66.

According to an embodiment visible in FIG. 13, the first flange portion 58.1 of at least one longitudinal beam out of the first and second end longitudinal beams 52.1, 52.8 is horizontal and supports a substantially horizontal panel 68.

Unlike in the prior art, in a transverse plane, the first and second flange portions 58.1, 58.2 converge at the web 56 at the same point P to avoid the appearance of a moment.

This arrangement can be applied to all the longitudinal beams 52.1 to 52.8.

According to an embodiment visible in FIGS. 7 and 9, the main landing gear bay 40 comprises at least a stay rod 70, 72 linking the rear or front transverse wall 42, 44 and the bottom wall 46, positioned approximately in the vertical median plane PMV, away from the front or rear edge 46.1, 46.2. According to one configuration, the main landing gear bay 40 comprises a rear stay rod 70 linking the rear transverse wall 42 and the bottom wall 46. According to another configuration, the main landing gear bay 40 comprises a rear stay rod 70 linking the rear transverse wall 42 and the bottom wall 46 and a front stay rod 72 linking the front transverse wall 44 and the bottom wall 46, the rear and front stay rods 70, 72 being positioned approximately in the vertical medial plane PMV.

Each stay rod 70, 72 makes it possible to limit the deformation of the bottom wall 46 in the event of significant pressure differences on either side of the bottom wall 46.

Each rear or front stay rod 70, 72 comprises a first end 70.1, 72.1 linked to a first anchoring point 74, 76 provided on the rear or front transverse wall 42, 44, and a second end 70.2, 72.2 linked to a second anchoring point 78, 80 provided on the bottom wall 46.

The first anchoring point 74 of the rear stay rod 70 is positioned in proximity to the bottom side 42.2 of the rear transverse wall 42. The first anchoring point 76 of the front stay rod 72 is positioned in proximity to the bottom side 44.2 of the front transverse wall 44.

For each rear or front stay rod 70, 72, the second anchoring point 78, 80 is separated from the rear or front edge 46.1, 46.2 of the bottom wall 46 by a distance L/4 corresponding to approximately a quarter of the length L of the bottom base 46 or a little less than a quarter of the length L. This position of the second anchoring points 78, 80 makes it possible to optimize the reinforcement of the bottom wall 46.

According to one embodiment, each second anchoring point 78, 80 is linked to the central longitudinal beams 52.4, 52.5 of the bottom wall 46 so as to ensure a better load transfer between the rear or front stay rod 70, 72 and the bottom wall 46.

Obviously, the invention is not limited to the main landing gear bay and can be applied to all the landing gear bays.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A landing gear bay comprising
a bottom wall having a rear edge,
a front edge parallel to the rear edge and at right angles to a vertical median plane, and
first and second lateral edges parallel to the vertical median plane,
the bottom wall comprising
longitudinal beams linking the rear and front edges, parallel to a vertical medial plane, and
at least one panel forming an airtight barrier between first and second zones disposed on either side of the panel, said panel having first and second longitudinal edges each linked to one of the longitudinal beams, the second zone being able to sustain a pressure greater than that of the first zone;
wherein the panel has a profile that is substantially constant in a longitudinal direction and comprises at least one central part offset toward the second zone with respect to first and second longitudinal edges thereof.

2. The landing gear bay as claimed in claim 1, wherein the first and second longitudinal edges are positioned in a same horizontal plane.

3. The landing gear bay as claimed in claim 1, wherein the panel has a curved profile in a transverse plane.

4. The landing gear bay as claimed in claim 1, wherein the panel comprises a substantially horizontal flat central part and first and second flat and inclined lateral parts such that the central part is offset toward the second zone with respect to the first and second longitudinal edges.

5. The landing gear bay as claimed in claim 1, wherein at least one longitudinal beam comprises a web, first and second flange portions, disposed on either side of the web, each supporting a panel, the first and second flange portions converging at the web.

6. The landing gear bay as claimed in claim 5, wherein the bottom wall comprises a first end longitudinal beam positioned in proximity to or at a first lateral edge, a second end longitudinal beam positioned in proximity to or at a second lateral edge, first and second central longitudinal beams disposed on either side of the vertical medial plane, a first pair of first and second intermediate longitudinal beams inserted between the first end and central longitudinal beams and a second pair of first and second intermediate longitudinal beams inserted between the second end and central longitudinal beams.

7. The landing gear bay as claimed in claim 6, wherein the bottom wall comprises a central panel linking the first and second central longitudinal beams, a first lateral panel linking the first end longitudinal beam and the first central longitudinal beam and a second lateral panel linking the second central longitudinal beam and the second end longitudinal beam, each of the first and second lateral panels having a central part offset toward the second zone with respect to first and second longitudinal edges of the first and second lateral panels positioned in a same horizontal plane.

8. The landing gear bay as claimed in claim 7, wherein one of the first and second flange portions of the first or second end longitudinal beam is inclined and has a free end offset toward the second zone and a face oriented toward the second zone against which the first or second longitudinal edge of the first or second lateral panel is pressed and fixed.

9. The landing gear bay as claimed in claim 7,
wherein the first flange portion of the first or second central longitudinal beam is inclined and has a free end offset toward the second zone and a face oriented toward the first zone against which the first or second longitudinal edge of the first or second lateral panel is pressed and fixed, and
wherein the second flange portion of the first or second central longitudinal beam is substantially horizontal and has a face oriented toward the first zone against which the first or second longitudinal edge of the central panel is pressed and fixed.

10. The landing gear bay as claimed in claim 7, wherein the first and second flange portions of each of the first and second intermediate longitudinal beams are inclined, the first or second lateral panel being pressed and fixed against the first and second flange portions.

11. The landing gear bay as claimed in claim 1, wherein at least one panel comprises transverse ribs added onto a face of the panel oriented toward the first zone.

12. An aircraft comprising a landing gear bay as claimed in claim 1.
